(19) United States
(12) Patent Application Publication
(10) Pub. No.: US 2019/0032337 A1
(43) Pub. Date: Jan. 31, 2019

(54) TRAFFICABLE COLORED ASPHALTIC MEMBRANE WITH MULTI-LAYER COATING

(71) Applicant: Megaflex S.A., Buenos Aires (AR)

(72) Inventors: Walter Sipag, Buenos Aires (AR); Antonio Alonso, Capital Federal (AR)

(73) Assignee: Megaflex S.A., Buenos Aires (AR)

(21) Appl. No.: 16/034,049

(22) Filed: Jul. 12, 2018

(30) Foreign Application Priority Data
Jul. 31, 2017 (AR) P20170101948

(51) Int. Cl. E04D 5/10; B32B 11/04

(52) U.S. Cl. CPC E04D 5/10; B32B 11/046; B32B 2419/06; B32B 2307/402; B32B 2307/7265

(57) ABSTRACT

A trafficable colored asphaltic membrane with multi-layer coating, to waterproof surfaces, which is composed of, at least, three layers: A non-stick inferior (1) layer comprised of a sheet of synthetic polymers, an intermediate (3) layer of asphaltic bitumen of suitable features for waterproofing and a superior (4) coating layer, wherein said superior coating layer is a laminated assembly obtained from coating by extrusion, comprised of a sheet of synthetic polymers, preferably polyester (5); a film comprised of mixtures of polymers Pead and/or Pebd (7); and a superior sheet (6) of synthetic polymers resistant to ultra violet rays (UV).

### BACKGROUND

The present disclosure relates to waterproofing of surfaces with asphaltic products, more specifically to waterproofing of surfaces with asphaltic coated products, and more specifically to waterproofing of surfaces with asphaltic products with anti-UV coating and of trafficable surfaces.

Waterproofing is the action by means of which a person manages to protect himself and his physical assets from outdoor environment and other natural phenomena. Waterproofing protects, together with enclosures (roofs, walls, floors, partition walls, etc.) hindering the passage of different agents, such as water and other fluids, avoiding the deterioration of elements and materials that make up the assembly to be protected. Apart from protecting, it isolates and addresses the different sources of humidity, generated by the facilities that provide support and cleaning required by the function of the assembly to be protected.

In waterproofing of constructions, and specially of roofs, the most divulged system is presently the one that is performed by means of the so-called “asphaltic membranes.” An asphaltic membrane is made of a plurality of layers of different materials, wherein at least one of its layers comprises of an asphaltic mass, which provides waterproof capacity. A feature of the asphalt is that it loses its waterproofing properties with age that is due to its exposure to outdoor environment, mainly due to the action of UV rays. Among the variables that cause the accelerated aging of the asphaltic membrane once same has been laid, we can mention the room thermal amplitude and the ultraviolet radiation. The mechanisms that intervene in the aging process are associated with changes of chemical, physical, mechanic and reologic nature. In general, alterations of chemical nature, such as volatilization, oxidation and polymerization, produce a rearrangement in the molecular structure of the asphalt and the response declaration to these changes lies in the hardening of the mixtures and therefore the mixture slowly turns into a fragile material, and may undergo cracking. The consequence of these changes is the appearance of cracks, or else the loss of mass due to volatilization, whereby the process of entrance of water and vapor to the interior of the mixture is begun, which leads to other processes of loss of cohesion and damages by humidity, thus reducing the performance of the asphalt.

The asphaltic membranes commonly used at present are basically made of three different components, achieving the advantages of each of their components and compensating the deficiencies of same.

Firstly, there is a non-stick layer, which function is to protect the asphaltic layer up to the moment of the laying of the membrane and, as well, it does not allow to be stuck to the asphaltic membrane when rolled.

On the other hand, a layer of asphaltic mass is provided, which can be present in a layer or else in two, with a sheet of different nature between them, that acts as structuring of the assembly, when the membrane in question needs to comply with some mechanic requirement in terms of elongation. As stated, the main feature of the asphaltic layer is its waterproof condition and its easy laying, specially on surfaces which are not flat, such as ridges or joints of walls and floors. This asphaltic mass is the layer that provides the actual waterproofing.

The asphalt is a binding material that is found in nature in solid and semi-solid form, of black or brown color, obtained from the distillation of oil. The essential issue of care of this material, for the purpose of waterproofing, is that it is sensitive to ultraviolet (UV) rays. The asphaltic mass gets aged with time, accelerated by the incidence of UV rays and loses its malleability, getting cracked with the consequent loss of waterproofing. Additionally, this asphaltic basis has reduced capacities of mechanic resistance of surface, specially to impact and pricking. The only function of the asphaltic layer is the waterproofing.

Due to the reasons stated above, to the asphaltic membranes that are laid and get exposed to the outdoor environment, a coating is added to protect the actual asphaltic layer, being said coating the third component of the asphaltic membrane. This third component preferably includes a lamination that grants the asphaltic layer a protection against UV rays and occasionally if same is appropriate to such end, an increase against surface mechanic resistance of the asphaltic membrane. Its function is to protect the asphaltic layer against weather changes, against pedestrian and animal traffic and against other actions that threaten to prick or damage the asphaltic layer. This lamination is preferably a metallic sheet, more preferable yet an aluminum sheet that, due to its good malleability, may come along with the laying of the asphaltic layer on non-flat surfaces. This metallic sheet protects the asphaltic layer from UV rays, simply because it reflects the sun rays that, hence, do not enter the asphaltic layer. It is also used as a protective coating of the asphaltic membrane, a granulated ground stone coating or else an appropriate granulated slate coating, or else a sheet of woven or not woven polyester tissue of different grammage, to be then painted with an acrylic coating. This latter option of coating (polyester to be painted later) gathers the qualities of higher resistance to pricking, either dynamic or static, than the two previous ones. Asphaltic membranes made with a superior coating of synthetic polymers, mixtures of polyetilene of high and low density (Pead/Pebd) are used only for laying on constructions in which they will not be exposed to weather agents such as the above mentioned ones, since that coating layer does not comply with its protective role against weather aspects, or outdoor environment, or against aggression due to pricking.

In case of asphaltic membranes coated with a polyester sheet, same are generally used when the requirements of use of the membrane are of high mechanic resistance or of high traffic, given the undoubted resistant characteristics these coatings have. Therefore, in common, this kind of membranes with polyester or “geotextile” coatings are called “trafficable.”

A feature to be taken into account of these trafficable membranes, which are normally provided in 10 m²-rolls, is that they have to be again covered with a paint or coating generally made of acrylic or of mixtures of resins, which protects the polyester sheet against UV rays, which affects them as far as costs are concerned. It is worth remembering that the polyester fiber is also a sub-product of the distillation of oil and therefore it also suffers with these issues of outdoor environment. The efficiency of performance of this kind of membranes in terms of mechanic resistance and of traffic is undoubted, but it requires a higher labor cost due to the superior painting that is made after the laying of the rolls over the surface to be waterproof, and specially due to the periodic maintenance (every 2/3 years, estimated) that said acrylic paint needs in order to keep its protective properties of the membrane.

Patent AR 050464 B1 of Megaflex of Aug. 19, 2005 reveals a multi-layer asphaltic sheet for waterproofing, made of several layers where the inferior layer is a polymer and the superior coating layer is a laminated assembly coated by extrusion. It also claims the method to produce said multi-layer asphaltic sheet. This patent is designed with a coating obtained from a laminated assembly coated by extrusion, basically obtained from the presence of a metallic foil, a film of synthetic polymers closely tied by a thin cast film obtained from mixtures of polymers (Pead/Pebd) at high temperature that thermally conform the coating in coated process.

The most remarkable feature, apart from the waterproofing, of the asphaltic membranes, either these be applied by heat or in cold, is, undoubtedly, the durability. The fact of having a system of waterproofing by means of a pre-elaborated sheet in a construction, constitutes a solution that has an expectation of very high performance in terms of years of use. In all cases, to apply asphaltic membranes, the use of primers is recommended.

### SUMMARY

Although “trafficable” asphaltic membranes have satisfactorily solved problems such as the protection of the actual asphaltic layer, either during manipulation of the laying of the rolls of asphaltic membranes as well as the traffic on said applied layer, the polyester coatings used at present have limitations of self-protection after the laying on surfaces to be waterproof, since they necessarily require successive processes of painting that imply labor and material costs, inevitably resulting in an increase of the final cost for a specialized laying, with painting work of less remaining protective quality as they are covered by subsequent paint coats.

On the other hand, the obvious aging of acrylic coatings that are provided as paints, requires to repeat every 2/3 years (according to the kind of used paint/coating) the process of re-painting of the asphaltic membrane with a superior polyester coating, in order to maintain the protective qualities of said acrylic coating with respect to the rest of the waterproofing.

The present disclosure, which uses once more the system of multi-layer coating obtained from coating by extrusion as a superficial ending of the membrane, is different and evolves patent AR 050464 B1 (of the same Applicant), since it changes the use of the metal (preferably aluminum) for a sheet of polyester fiber, which results in an assembly that allows a higher mechanic resistance against dynamic and static pricking, and even high trafficability without subsequent maintenance.

An objective of this present disclosure is to provide an asphaltic membrane with a subsequent UV protective coating in the actual polyester sheet.

Another objective of the present disclosure is to provide an asphaltic membrane with a superior polyester protective coating of high resistance and trafficability and that also supports and protects against UV rays for all the laminated assembly.

Another objective of the present disclosure is to provide an asphaltic membrane of high level of durability and low cost of installation.

Another objective of the present disclosure is to provide an asphaltic membrane that, maintaining the qualities of resistance and trafficability, requires less maintenance than the actually existing membranes in the market.

Another objective of the present disclosure is to provide an asphaltic membrane that does not require maintenance labor after its installation.

Another objective of the present disclosure is to provide an asphaltic membrane of different colors on its superior coating so as to help it mimicking with the place where it is applied.

The Applicant does not know in the previous art any waterproof asphaltic membrane that meets the conditions of the present disclosure: A trafficable asphaltic membrane with superior polyester coating protected with a film of synthetic polymers that does not require to be painted nor maintained after its installation; with high protection of the assembly against UV rays, and with provision of different colors, for the purpose of decoration, on its superior coating.

### BRIEF DESCRIPTION OF THE DRAWINGS

FIG. 1 shows a perspective view of a roll of asphaltic membrane of a unique layer of asphaltic bitumen according to the present disclosure.

FIG. 2 shows a perspective view of a roll of asphaltic membrane of two layers of asphaltic bitumen according to the present disclosure.

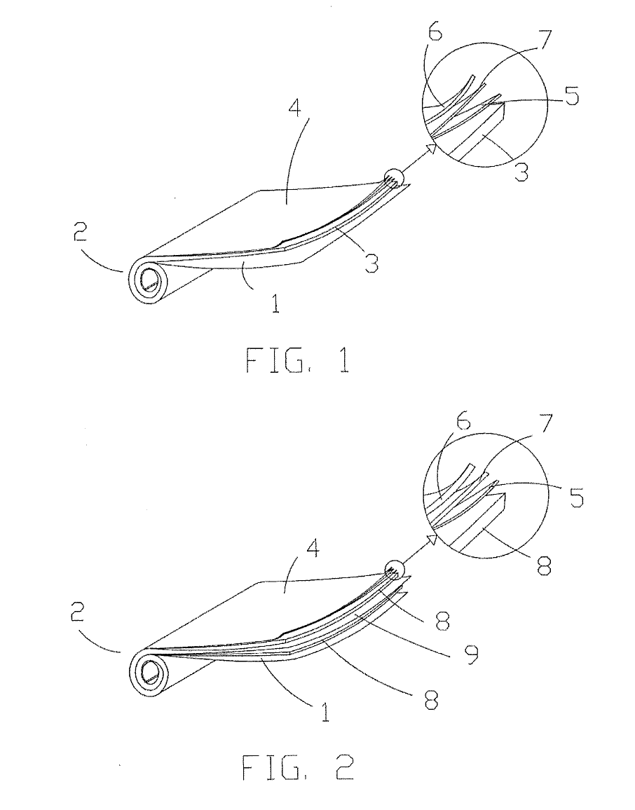

### DETAILED DESCRIPTION

The asphaltic mass needs a protection to filter the UV rays so as to avoid its aging and to extend its useful life. This function is performed by the superior coating layer that, in the art, may be a metallic foil, preferably aluminum or copper, or slate, or ground rock introduced within the superior part of the asphaltic mass, or polyester films coated with acrylic paint. When a membrane coated with a polyester sheet, generally of non-woven material, is preferred, what it is seeked is the resistance of the waterproof solution against possible aggressions due to pricking and above all, the aptitude for its trafficability.

The asphaltic membrane with trafficable colored multi-layer coating to waterproof in the present disclosure, that includes at least three layers of material.

A first inferior layer 1, called “non-stick layer,” is formed by a sheet of synthetic polymers that help the membrane to manipulate, to conform its laying and, specially to allow its provision in rolls 2 without the asphaltic layer being stuck.

An intermediate asphaltic layer 3 is stuck to said inferior layer 1, identified as “asphaltic layer” comprised of asphaltic bitumen that plays the role of waterproofing.

The third layer 4 of the asphaltic membrane, the superior one known as “coating,” is a multi-layer laminated assembly obtained from coating by extrusion with resistant characteristics against UV rays, which, in turn, may be provided in a range of different colors.

The characteristics of the superior layer, that is of the multi-layer laminated assembly, is that same is comprised of a polyester sheet 5 of high resistance and a sheet 6 of synthetic polymers that contain anti-UV additives and is pigmented with different decorative colors, each other adhered by a mass 7 comprised of mixtures of polymers of Pead and/or Pebd, applied at high temperature (coated by extrusion) thermally conforming said laminated assembly, and turning same in a layer of superior coating of the membrane.

In a second embodiment, the asphaltic layer 8 is made of two asphaltic layers, each other separated by a “reinforcement” or “central core” 9. This reinforcement is comprised of a synthetic polymer, preferably a polyester, a polyetilene, or a polypropylene.

The above description and drawings are only to be considered illustrative of specific embodiments, which achieve the features and advantages described herein. Modifications and substitutions for specific conditions and materials and otherwise can be made. Accordingly, the inventions are not considered as being limited by the foregoing description and drawings, but are intended to embrace all such alternatives, modifications, substitutes and variances.

The objectives of the disclosures include any combination or sub-combination of the elements of the different types and/or disclosures described herein. People skilled in the art will recognize that those properties and, consequently the scope of the present inventions, should be construed in the light of the following claims and everything equivalent to them.

What is claimed as new and desired to be protected by Letters Patent of the United States is:

1. An asphaltic membrane with trafficable colored multi-layer coating, to waterproofing surfaces, consisting of at least three layers: A non-stick inferior (1) layer comprised of a sheet of synthetic polymers, an intermediate (3) layer of asphaltic bitumen of suitable features for waterproofing and a superior (4) coating layer, wherein said superior coating layer is a laminated assembly obtained from coating by extrusion, comprised of a sheet of synthetic polymers, preferably polyester (5); a film comprised of mixtures of polymers Pead and/or Pebd (7); and a superior sheet (6) of synthetic polymers resistant to ultra violet rays (UV).

2. The trafficable colored asphaltic membrane with multi-layer coating of claim 1, wherein the sheet of synthetic polymer resistant to UV of the superior layer has, as additives, anti UV polymers.

3. The trafficable colored asphaltic membrane with multi-layer coating of claim 1, wherein said synthetic polymer resistant to UV rays is presented as well, composed of pigmented polymers that serve as a dye of the superior coating.

4. The trafficable colored asphaltic membrane with multi-layer coating of claim 1, wherein it also includes a second layer of asphaltic bitumen separated by a sheet of synthetic polymers that serve as a reinforcement (9).

5. The trafficable colored asphaltic membrane of multi-layer coating of claim 4, wherein one of the layers of asphaltic bitumen provides different adhesive characteristics than the other asphaltic bitumen.

6. The trafficable colored asphaltic membrane with multi-layer coating of claim 4, wherein said synthetic polymer is a polyester, polyetilene or polypropylene.
